(19) United States
(12) Patent Application Publication
(10) Pub. No.: US 2023/0189865 A1
(43) Pub. Date: Jun. 22, 2023

(54) INFANT FORMULA

(71) Applicant: ENCHANTED ACRES FARMS, INC., Reading, PA (US)

(72) Inventor: Kelley Huff, Birdsboro, PA (US)

(21) Appl. No.: 17/925,363

(22) PCT Filed: May 14, 2021
(86) PCT No.: PCT/US2021/032632

§ 371 Date: Nov. 15, 2022

Related U.S. Application Data
(60) Provisional application No. 63/025,453, filed on May 15, 2020.

(51) Int. Cl. A23L 33/00; A23L 33/125; A23L 33/12; A23L 33/19; A23L 33/16; A23L 33/175; A23L 33/13; A23L 33/155

(52) U.S. Cl. CPC A23L 33/40; A23L 33/125; A23L 33/12; A23L 33/19; A23L 33/16; A23L 33/175; A23L 33/13; A23L 33/155

(57) ABSTRACT

Embodiments disclosed relate to a nutritional formula having non-fat milk powder, lactose, an oil blend, enriched whey protein concentrate, oligosaccharides, choline, arachidonic acid (ACA), docosahexaenoic acid (DHA), magnesium oxide, sodium citrate, lactoferrin, inositol, taurine, iron, L-carnitine, zinc, nucleotides, soy lecithin, pantothenic acid, copper, D-biotin, folic acid, lutein, manganese sulfate, iodine, Beta-carotene, and selenium, and to methods of delivering nutrition to a subject.

### CROSS-REFERENCE OF RELATED APPLICATION

This application claims priority to U.S. Provisional Application No. 63/025,453 filed May 15, 2020; the entire contents of all of which are hereby incorporated by reference.

### BACKGROUND

### 1. Technical Field

The field of the currently claimed embodiments of this invention relate to nutritional formulas and methods of providing nutrition to a subject.

### 2. Discussion of Related Art

Nutritional formula for infant consumption is a manufactured food designed and marketed for feeding to babies and infants under 12 months of age, usually prepared for bottle-feeding or cup-feeding from powder (mixed with water) or liquid (with or without additional water). Such formulas are designed for special dietary use as a food for infants and are formulated to simulate human milk and function as a complete or partial substitute for human milk.

Traditional infant formulas have been associated with several undesirable side effects in the infant including unhealthy weight gain and intestinal issues. These side effects have been linked to the fact that these formulas generally have higher levels of total protein than natural breast milk. In addition, the protein composition of traditional formulas differs greatly from the protein composition of natural breast milk. Thus, there is a need for the development of manufactured infant formulas that more closely resemble the protein levels and composition of natural breast milk.

### INCORPORATION BY REFERENCE

All publications and patent applications identified herein are incorporated by reference in their entirety and to the same extent as if each individual publication or patent application was specifically and individually indicated to be incorporated by reference.

### SUMMARY

An embodiment relates to a nutritional formula having non-fat milk powder, lactose, an oil blend, enriched whey protein concentrate, oligosaccharides, choline, arachidonic acid (ACA), docosahexaenoic acid (DHA), magnesium oxide, sodium, lactoferrin, inositol, taurine, iron, L-carnitine, zinc, nucleotides, soy lecithin, pantothenic acid, copper, D-biotin, folic acid, lutein, manganese sulfate, iodine, Beta-carotene, sodium citrate, and selenium. The invention also relates to is a method of providing nutrition to a subject, the method including: reconstituting any formula discussed above with water to form a ready-to-feed liquid

A further embodiment relates a method of providing nutrition to a subject, the method including administering formula discussed above to the subject.

An embodiment also relates to a kit having: one or more packages of the nutritional formula discussed above; and instructions for feeding the nutritional formula to a subject.

### BRIEF DESCRIPTION OF THE DRAWINGS

FIG. 1 is a graph showing that the fatty acid content of a formula closely resembles that of breast milk, according to an embodiment of the invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

### 1. Definitions

To facilitate an understanding of the present invention, a number of terms and phrases are defined below.

The terms “nutritional formula” and “infant formula” are used interchangeably herein and refer to a nutritional composition that is designed for the administration of sufficient fat, protein, carbohydrate, vitamins, minerals, prebiotics, and other nutrients to a subject. The nutritional formula may be the sole source of nutrition when provided in sufficient quantity. The nutritional formula is suitable for consumption by a subject in need thereof as described herein, including, but not limited to, infants.

The term “formula” encompasses any form of the nutritional formula described herein, including, but not limited to, powder and liquid formulae. Additionally, the powder can be reconstituted from a dehydrated powder form to yield a liquid form suitable for the administration of the formula to a subject, including an infant.

The term “ready-to-feed” used herein refers to a liquid formula suitable for administration to a subject, including reconstituted powders, diluted formulas of a concentrated nutritional formula, and manufactured liquids.

As used herein, concentrations expressed as micrograms per liter (“μA”), milligrams per liter (“mg/L”), and grams per liter (“g/L”) refer to ingredient concentrations within the nutritional formulation of the present invention calculated on a reconstituted, ready-to-feed, or fed basis, unless otherwise specified.

The term “about X,” or “approximately X,” where X is a number or percentage, refers to a number or percentage that is, for example, between 99.5% and 100.5%, between 99% and 101%, between 98% and 102%, between 97% and 103%, between 96% and 104%, between 95% and 105%, between 92% and 108%, or between 90% and 110%, inclusive, of X.

As used herein, a “subject” is a mammal. In certain embodiments, the mammal is an animal. In certain embodiments, the animal is a human. In certain embodiments, the human is an adult, adolescent, child, toddler, infant, or newborn of either sex. An “infant” or “newborn” refers to a human not more than about two years of age. The term “infant” also includes an infant from about 0 to about 4 months of age, from about 4 to about 8 months of age, from about 8 to about 12 months of age, from about 12 to about 16 months of age, from about 16 to about 18 months of age, and from about 18 to about 24 months of age, and preterm infants that are less than about 37 weeks gestational age. A “newborn” is an infant that is not more than about 4 weeks of age, and includes an infant from about 0 to about 1 week of age, from about 1 to about 2 weeks of age, from about 2 to about 3 weeks of age, and from about 3 to about 4 weeks of age. In certain embodiments, the animal is non-human. In certain embodiments, the non-human animal is a cow, sheep, buffalo, goat, camel, donkey, horse, or any other non-human animal that produces milk.

A “protein,” “peptide,” or “polypeptide” comprises a polymer of amino acid residues linked together by peptide bonds. The term refers to proteins, polypeptides, and peptides of any size, structure, or function. Typically, a protein will be at least three amino acids long.

“Whey protein concentrate” is a concentrated form of whey protein. The term whey protein concentrate encompasses whey protein of any size, structure, or function, and from any source or any composition. In nutrition, whey protein concentrate may be used to increase dietary protein intake. In general, whey protein concentrate contains from about 20% to about 90% protein by weight.

“Demineralized whey” or “reduced-minerals whey” refers to, with reference to a purification process, whey protein in which the minerals and salts (organic and inorganic) have been removed. In some embodiments, between 25-90% of the minerals in the whey protein in the demineralized whey are removed. In some embodiments, up to 25% of the minerals in the whey protein in the demineralized whey are removed. In some embodiments, up to 50% of the minerals in the whey protein in the demineralized whey are removed. In some embodiments, up to 60% of the minerals in the whey protein in the demineralized whey are removed. In some embodiments, up to 75% of the minerals in the whey protein in the demineralized whey are removed. In some embodiments, up to 80% of the minerals in the whey protein in the demineralized whey are removed. In some embodiments, up to 90% of the minerals in the whey protein in the demineralized whey are removed.

The term “skimmed milk” or “non-fat milk” refers to a product that results from the removal of fat and water from pasteurized milk. The terms skimmed milk and non-fat milk also encompass “skim milk powder” and “non-fat milk powder” In skimmed milk, the fat content or protein content or both in the milk can be altered by the removal or addition of milk constituents. Milk retentate, milk permeate, and lactose can be used to adjust the skimmed milk powder protein content. Skimmed milk retains the original whey protein to casein ratio present in the milk. The production of skimmed milk powder often involves, but is not limited to, the evaporation of moisture from the milk until a dry powder with a low moisture content is obtained. The milk used to produce the skimmed milk powder as described herein can be obtained from any source. As described herein, skimmed milk or slim milk powder can be obtained from any source.

The term “enriched” refers to a protein fraction having a high amount of a specified protein. In some embodiments, the protein fraction enriched with a specified protein has at least 30% of the specified enriched protein. In some embodiments, the protein fraction enriched with a specified protein has at least 40% of the specified protein. In some embodiments, the protein fraction enriched with a specified protein has at least 50% of the specified protein. In some embodiments, the protein fraction enriched with a specified protein has at least 60% of the specified protein. In some embodiments, the protein fraction enriched with a specified protein has at least 65% of the specified protein. In some embodiments, the protein fraction enriched with a specified protein has at least 70% of the specified protein. In some embodiments, the protein fraction enriched with a specified protein has at least 80% of the specified protein. In some embodiments, the protein fraction enriched with a specified protein has at least 90% of the specified protein.

“Lactoferrin” is a protein produced during the late stages of pregnancy and is found in breast milk colostrum and mature breast milk. Lactoferrin is classified as a glycoprotein, in which normally about 1 to about 4 glycans are attached to amino acid side chains throughout the protein. Lactoferrin aids in intestinal development and iron absorption, as well as provides immune system support. As described herein, the lactoferrin can be obtained from any source.

A “fat,” “triglyceride,” “lipid,” or “oil” is comprised of three fatty acid chains connected to a glycerol molecule through an ester bond. The term fat refers to all fat, triglyceride, and oil molecules of any size, structure, or function. Typically, a fat is a hydrophobic molecule that is insoluble in water. An oil is generally an unsaturated fatty acid chains. Fats may include fatty acid chains that are either saturated or unsaturated. A saturated fat contains no double bonds between carbon atoms in the chain. An unsaturated fat contains one or more double bonds between carbon atoms in the chain, and the double bond or bonds can be in the cis or trans configuration. Fats containing one or more trans double bonds are called trans fats. Fat containing one or more cis double bonds are called cis fats. Further, a monounsaturated fatty acid contains at least one double bond between carbons in the aliphatic chain. A polyunsaturated fat that contains at least one aliphatic chains with at least two or more double bonds between carbons in the chain. Sources of fat and oils, including saturated, unsaturated, and polyunsaturated fat, include, but are not limited to, canola, sunflower, sesame, peanut, walnut, chia, palm, coconut, avocado, olive, safflower, seaweed, sardine, soybean, tuna, salmon, and whole grain wheat.

“Oleic acid” or “C18:1” is a naturally occurring fatty acid in a variety of animal and vegetable oils. The term oleic acid as described herein encompasses fatty acids under the IUPAC nomenclature “(9E)-octadec-9-enoic acid.” Oleic acid includes salts or esters of oleic acid, and is from any source. Oleic acid is further classified as an omega-9 cis monounsaturated fatty acid with one double bond at carbon 9 and a total of 18 carbons in the aliphatic chain (18:1 cis-9).

“Palmitic acid” or “C16:0” is the most common fatty acid found in animals, plants, and microorganisms, such as algae and fungi. The term palmitic acid as described herein encompasses all fatty acids under the IUPAC nomenclature “hexadecanoic acid.” Palmitic acid includes salts or esters of palmitic acid, and is from any source. Palmitic acid is further classified as a saturated fatty acid and consists of a 16 carbon aliphatic chain (16:0).

“OPO SN-2 oil,” “OPO” or “oleic acid-palmitic acid-oleic acid triglyceride” refers to an oleic acid-palmitic acid-oleic acid triglyceride, wherein palmitic acid is at the SN-2 position of the glycerol backbone of the triglyceride. In some embodiments, the SN-2 position of the glycerol backbone of the triglyceride is the second position on the glycerol backbone of the triglyceride. OPO SN-2 oil may refer to an oleic acid-palmitic acid-oleic acid triglyceride. Optionally, the fatty acid side chain may also be attached to the first position (SN-1) of the glycerol backbone. Optionally, the fatty acid side chain may be attached to the third position (SN-3) of the glycerol backbone. Optionally, about 50% to about 100% of the triglycerides in the OPO SN-2 oil are SN-2 triglycerides.

“Microencapsulated,” “microencapsulation,” or “microcapsule” refers to any substance, particle, or droplet surrounded by a coating of any material to give small capsules or the process of producing such capsules. Optionally, the coating material may include a carbohydrate (e.g., ethyl cellulose or sodium alginate), alcohol (e.g., polyvinyl alcohol), protein (e.g., sodium alginate), or combinations thereof. The term microencapsulated may refer to any food ingredient, enzyme, cell, or other material that may be incorporated into the relevant composition, mixture, ingredient, or product. Microencapsulation may be used to enclose any solid, liquid, or gaseous substance. Optionally, the microcapsule may be used to enclose any substance permanently or temporarily. The term microencapsulation covers all physical, chemical, and physiochemical techniques used in the process of generating microcapsules, including pan coating, air-suspension coating, centrifugal extrusion, vibrational nozzle, spray-drying, ionotropic gelation, coacervation-phase separation, interfacial polycondensation, interfacial cross-linking, in-situ polymerization, matrix polymerization, or the combination of techniques described herein.

“Docosahexaenoic acid” or “DHA” is an omega-3 fatty acid comprising a 22 carbon chain and 6 cis double bonds. The terms docosahexaenoic acid and DHA also encompass “cervonic acid,” “all-cis-docosa-4,7,10,13,16,19-hexaenoic acid,” “22:6(n-3),” and any fatty acid that can be classified under the IUPAC nomenclature “(4Z,7Z,10Z,13Z,16Z,19Z)-docosa-4,7,10,13,16,19-hexaenoic acid” and “doconexent”. The terms docosahexaenoic acid and DHA may refer to any docosahexaenoic acid of any size, structure, or function. The docosahexaenoic acid defined herein may be from any source, including milk and/or oil, or a combination thereof. In certain embodiments, the milk is maternal milk, breast milk, and any combination thereof. In certain embodiments, the oil is fish oil, algae oil, microalgae oil, and any combination thereof. In certain embodiments, the docosahexaenoic acid is sourced from Crypthecodinium cohnii oil. In certain embodiments, the docosahexaenoic acid is sourced from fish oil. In certain embodiments, the docosahexaenoic acid is microencapsulated.

“Arachidonic acid” or “ARA” is a polyunsaturated omega-6 fatty acid comprising a 20 carbon aliphatic chain and 4 cis double bonds. The terms arachidonic acid and ARA also encompass “(5Z,8Z,11Z,14Z)-Icosa-5,8,11,14-tetraenoic acid,” “5,8,11,14-all-cis-eicosatetraenoic acid,” “all-cis-5,8,11,14-eicosatetraenoic acid,” “arachidonate,” and any fatty acid that can be classified under the IUPAC nomenclature “(5Z,8Z,11Z,14Z)-5,8,11,14-eicosatetraenoic acid”. The arachidonic acid defined herein may be from any source, including milk and/or oil, or a combination thereof. In certain embodiments, the milk is maternal milk, breast milk, and any combination thereof. In certain embodiments, the oil is fish oil, algae oil, microalgae oil, and any combination thereof. In certain embodiments, the arachidonic acid is sourced from Mortierella alpina oil. In certain embodiments, the arachidonic acid is microencapsulated.

A “carbohydrate,” “saccharide,” “sugar,” or “starch” is a molecule comprised of carbon, hydrogen, and oxygen atoms. The term carbohydrate refers to all carbohydrate, saccharide, sugar, or starch molecules of any size, structure, or function. A carbohydrate can be a monosaccharide or a single sugar molecule. Two or more monosaccharides may be joined by one or more glycosidic bonds to produce higher order carbohydrates. A disaccharide is a carbohydrate comprised of two monosaccharides, an oligosaccharide is comprised of about 3 to about 10 monosaccharides, and a polysaccharide is comprised of about 10 or more monosaccharides. In certain embodiments, the carbohydrate is lactose, maltodextrin, corn syrup, corn syrup solids, and any combination thereof. In certain embodiments, the carbohydrate is lactose, maltodextrin, or any combination thereof.

“Lactose” is a disaccharide carbohydrate. Lactose contains a galactose moiety and a glucose moiety linked by a glycosidic bond. The term lactose refers to any lactose of any size, structure, or function. The term lactose also encompasses “milk sugar,” “4-O-β-D-galactopyranosyl-D-glucose,” and any carbohydrate classified under the IUPAC nomenclature “β-D-galactopyranosyl-(1→4)-D-glucose”.

“Maltodextrin” is a polysaccharide comprising D-glucose units connected in chains of any length. Optionally, the maltodextrin chain is between about 2 to about 17 glucose units long, and may exists as a mixture of chain lengths between about 2 to about 17 glucose units long. The term maltodextrin encompasses any maltodextrin of any size, structure, or function, and from any source.

An “antioxidant” is a molecule that can prevent the oxidation of another molecule. The term antioxidant refers to all antioxidants of any size, structure, or function. An antioxidant functions to prevent chain reactions produced by free radicals, or any atom, ion, or molecule with an unpaired electron, that arise through a variety of natural, biological, and metabolic oxidation reactions. Antioxidants may be sulfur-containing compounds, such as glutathione, an enzyme, or a dietary antioxidant. Typical dietary antioxidants may include vitamin A, vitamin C, vitamin E, lutein, and others.

“Lutein” is a xanthophyll, a division of the carotenoid group, with a yellow pigment. The term lutein also encompasses “luteine,” “trans-lutein,” “(1R) [(1E,3E,5E,7E,9E,11E,13E,15E,17E)-18-[(1R,4R)-4-hydroxy-2,6,6-trimethylcyclohex-2-en yl]-3,7,12,16-tetramethyloctadeca-1,3,5,7,9,11,13,15,17-nonaenyl]-3,5,5-trimethylcyclohex en-1-ol,” and any xanthophyll or carotenoid that can be classified under the IUPAC nomenclature “β,ϵ-carotene-3,3′-diol.” The term lutein encompasses any maltodextrin of any size, structure, or function, and from any source.

“Prebiotic” or “prebiotics” refers to a compound that may induce the growth and beneficial activity of host microorganisms, such as bacteria, fungi, or others. A prebiotic refers to all prebiotics of any size, structure, or function. A prebiotic may be from plant or animal sources. A prebiotic may be from human milk. In nutrition, a prebiotic is commonly a compound comprising dietary fiber, wherein the dietary fiber contains a soluble portion and an insoluble portion, and the fiber aids in digestion. A prebiotic commonly alters and effects the microorganisms living in the gastrointestinal tract of the host, and often influences microorganisms or microflora in the gut and elsewhere in the body. Prebiotics suitable for nutritional formulas include, but are not limited to, galactooligosaccharides, inulin, fructooligosaccharides, polydextrose, and human milk oligosaccharides including sialyllacto-N-tetraose, lactodifucotetraose, 3′-sialyllactose, 6′-sialyllactose, 3′-fucosyllactose, lacto-N-(neo)tetraose, lacto-N-fucopentaose, and T-fucosyllactose. Preferably, the nutritional composition contains galactooligosaccharides, polydextrose, or any combination thereof. Optionally, the nutritional formula includes galactooligosaccharides, polydextrose, and one or more additional prebiotics.

A “vitamin” or “nutrient” is an organic or inorganic compound that is required by an organism. The term vitamin refers to a vitamin or nutrient of any size, structure, or function. The term vitamin may also refer to a vitamin within a complex or coenzyme. Vitamins are any compound required by an organism that the organism cannot synthesize for itself and must be obtained from the organism's diet. Vitamins required by humans may include, but are not limited to, vitamin A, vitamin B1, vitamin B2, vitamin B3, vitamin B5, vitamin B6, vitamin B7, vitamin B9, vitamin B12, vitamin C, vitamin D, vitamin E, vitamin K1, folic acid, inositol, biotin, niacin, and the chemical nomenclature derivatives or variants of these named vitamins.

A “dietary mineral,” “mineral,” “trace mineral,” “dietary element,” or “mineral nutrient” is any chemical element required by living organisms. The term mineral or dietary mineral refers to a dietary mineral, dietary element, or mineral nutrient of any size, structure, or function. A dietary mineral does not include carbon, hydrogen, oxygen, or nitrogen due to their presence in common organic molecules. Dietary minerals important for humans include, but are not limited to, sulfur, potassium, chloride, sodium, calcium, phosphorous, magnesium, zinc, iron, manganese, copper, iodine, selenium, molybdenum, cobalt, and bromine.

A “nucleotide” is an organic molecule that serves as the basic subunit of nucleic acids such as deoxyribonucleic acid (DNA) and ribonucleic acid (RNA). The term nucleotide refers to a nucleotide of any size, structure, or function. Nucleotides are typically comprised of a nitrogenous base (nucleobase), a 5- or 6-carbon sugar unit, and at least one phosphate group. Nucleotides serve as energy storage molecules in the cell, commonly in the form of nucleotide triphosphates, and are central to metabolism. The primary nucleobases are cytosine, guanine, adenine, thymine, and uracil. When a nucleobase is connected to a sugar and at least one phosphate group, the nucleotide base is formed. Common nucleotides include cytidine 5′-monophosphate (CMP), uridine 5′-monophosphate (UMP), guanosine 5′-monophosphate (GMP), and adenosine 5′-monophosphate (AMP), and salts thereof, among others.

“Lecithin” is a term used to define any fatty acid or substance that occurs naturally in a plant or animal tissue. Lecithin is a yellow-brown amphiphilic substance. In certain embodiments, lecithin may be used for smoothing food textures, dissolving powders, homogenizing liquid mixtures, repelling sticking materials, as an emulsifier, or any combination thereof. The term lecithin may also refer to any phospholipid or glycerophospholipid contained within. The term lecithin encompasses any lecithin of any size, structure, or function, and from any source. In certain embodiments, the source of lecithin is soy, soya, soybeans, eggs, milk, marine sources, rapeseed, cottonseed, sunflower, and any combination thereof. In certain embodiments, the lecithin source is soya lecithin.

“L-choline bitartrate” is a water soluble nutrient. L-choline bitartrate is a salt or monoester of choline and tartaric acid. L-choline bitartrate encompasses any salt containing the N,N,N-trimethylethanolammonium cation and complementary tartaric acid derived anion. In certain embodiments, choline bitartrate is a mixture of D/L-choline bitartrate. L-choline bitartrate contains only the L-enantiomer of choline bitartrate. In certain embodiments, L-choline bitartrate is conditioned. In certain embodiments, L-choline bitartrate is conditioned or coated with silica.

“L-carnitine” is an amino acid derivative. L-carnitine is involved in lipid and fat metabolism in mammals and other eukaryotes. The term L-carnitine encompasses any carnitine that can be classified under the IUPAC nomenclature “3-hydroxy (trimethylazaniumyl)butanoate”. L-carnitine can be from any food, plant, or animal source. In certain embodiments, L-carnitine is from a plant source. In certain embodiments, L-carnitine is from an animal source. L-carnitine comprises solely the biologically active L-enantiomer of carnitine.

“Beta-carotene” is a carotene, a class of terpenoids or isoprenoids. Beta-carotene is an organic pigment that has an orange or red color and is abundant in many plants and fruits. Generally, beta-carotene has about 40 carbons. The term beta-carotene also encompasses “betacarotene,” “β-carotene,” “Food Orange 5,” “Provitamin A,” “1,1′-(3,7,12,16-Tetramethyl-1,3,5,7,9,11,13,15,17-octadecanonaene-1,18-diyl)bis[2,6,6-trimethylcyclohexene],” and any carotene, terpenoid, or isoprenoid that can be classified under the IUPAC nomenclature “1,3,3-trimethyl-2-[3,7,12,16-tetramethyl-18-(2,6,6-trimethylcyclohex-1-en-1-yl) octadeca-1,3,5,7,9,11,13,15,17-nonaen-1-yl]cyclohex-1-ene.” Beta-carotene can be from any food, plant, or animal source. In certain embodiments, beta-carotene is from a plant source. In certain embodiments, beta-carotene is from an animal source.

“Taurine” or “2-aminoethanesulfonic acid” is an organic compound that serves a variety of biological roles, such as conjugation of bile acids, antioxidation, osmoregulation, membrane stabilization, calcium signaling modulation, development and function of skeletal muscle, development and function of the retina, and development and function of the central nervous system. The term “taurine” encompasses any molecule that can be classified under the IUPAC nomenclature “2-aminoethanesulfonic acid.” The taurine defined herein may be from any source. In certain embodiments, taurine is from an animal source.

An “effective amount” of a nutritional formula described herein refers to an amount sufficient to provide nutrition to a subject. An effective amount of a nutritional formula described herein may vary depending on such factors as the desired biological endpoint (e.g., promoting to a certain degree the postnatal development of an infant's gastrointestinal functions, nutrient absorption, immune system development), the mode of administration, and the age and health of the subject. In certain embodiments, an effective amount is a therapeutically effective amount. In certain embodiments, an effective amount is the amount of a nutritional formula described herein in a single serving. In certain embodiments, an effective amount is the amount of a nutritional formula described herein in a single feeding. In certain embodiments, an effective amount is the combined amounts of a nutritional formula described herein in multiple servings. In certain embodiments, an effective amount is the combined amounts of a nutritional formula described herein in multiple feedings.

Some embodiments of the present invention are directed to a nutritional formula having non-fat milk, lactose, a vegetable oil, demineralized whey powder, whey protein concentrate, enriched whey protein concentrate, a galacto-oligosaccharide (GOS), a fructo-oligosaccharide (FOS), arachidonic acid (ACA), docosahexaenoic acid (DHA), calcium carbonate, di-calcium phosphate, potassium citrate, potassium chloride, potassium iodide, magnesium oxide, magnesium chloride, sodium citrate, zinc sulfate, copper sulfate, manganese sulfate, sodium selenite, soy lecithin, L-choline bitartrate, L-ascorbic acid, niacinamide, D-calcium pantothenate, vitamin A palmitate, vitamin B12, vitamin D3, riboflavin, thiamin hydrochloride, vitamin B6 hydrochloride, folic acid, vitamin K1, D-biotin, inositol, vitamin E, cytidine 5′-monophosphate, disodium uridine 5′-monophosphate, adenosine 5′-monophosphate, Beta-carotene, lactoferrin, taurine, and L-Carnitine.

Some embodiments of the present invention are directed to a nutritional formula having non-fat milk powder, lactose, an oil blend, demineralized whey powder, whey protein concentrate, enriched whey protein concentrate, a galacto-oligosaccharide (GOS), a fructo-oligosaccharide (FOS), choline, calcium carbonate, potassium chloride, arachidonic acid (ARA), docosahexaenoic acid (DHA), magnesium oxide, sodium, vitamin C, lactoferrin, inositol, taurine, iron, L-carnitine, zinc, cytidine 5′-monophosphate, disodium uridine 5′-monophosphate, vitamin B3, soy lecithin, pantothenic acid, disodium guanosine-5 monophosphate, vitamin K1, vitamin B2, copper, vitamin A, D-biotin, vitamin B12, potassium citrate, vitamin B1, folic acid, vitamin B6, lutein, manganese sulfate, iodine, Beta-carotene, selenium, vitamin D3, 1,3-dioleoyl-2-palmitoyl-glycerol, coconut oil, soy oil, sunflower oil, Mortierella alpine oil, Crypthecodinium cohnii oil, di-calcium phosphate, maltodextrin, magnesium chloride, dl-a-vitamin E acetate, Adenosine 5′-Monophophate, or combinations thereof. In some embodiments, choline is included as choline bitartrate; iron is included as ferrous sulphate, iodine is included as potassium iodide, sodium is included as sodium citrate, zinc is included as zinc sulfate, copper sulfate is included, selenium is included as sodium selenite, vitamin C is included as ascorbic acid, vitamin B3 is included as niacinamide, pantothenic acid is included as D-Calcium Pantothenate, vitamin A is included as Vitamin A Palmitate, Vitamin B12 is included as Vitamin B12 (cyanocobalamin), vitamin B2 is included as riboflavin, vitamin B1 is included as Thiamin Hydrochloride, vitamin B6 is included as Vitamin B6 Hydrochloride. Crypthecodinium cohnii oil is included as a source of docosahexaenoic acid (DHA), and Mortierella alpine oil is included as a source of arachidonic acid (ARA).

An embodiment relates to a nutritional formula having non-fat milk powder, lactose, an oil blend, enriched whey protein concentrate, oligosaccharides, choline, arachidonic acid (ACA), docosahexaenoic acid (DHA), magnesium oxide, sodium, lactoferrin, inositol, taurine, iron, L-carnitine, zinc, nucleotides, soy lecithin, pantothenic acid, copper, D-biotin, folic acid, lutein, manganese sulfate, iodine, Beta-carotene, sodium citrate, and selenium.

An embodiment relates to the nutritional formula above, further having one or more of demineralized whey powder and whey protein concentrate.

An embodiment relates to the nutritional formula above, where the oligosaccharides comprise galacto-oligosaccharide (GOS), fructo-oligosaccharide (FOS), or combinations thereof.

An embodiment relates to the nutritional formula above, further having one or more of calcium carbonate, di-calcium phosphate, potassium citrate, potassium chloride, potassium iodide, magnesium chloride, sodium citrate, sodium chloride, zinc sulfate, copper sulfate, and sodium selenite.

An embodiment relates to the nutritional formula above, where the vitamins comprise L-ascorbic acid, ascorbyl palmitate, niacinamide, D-calcium pantothenate, vitamin A, vitamin A palmitate, vitamin B1, vitamin B2, vitamin B3, vitamin B6, vitamin B12, vitamin C, vitamin D3, riboflavin, thiamin hydrochloride, vitamin B6 hydrochloride, folic acid, vitamin K1, vitamin E, or combinations thereof.

An embodiment relates to the nutritional formula above, where the nucleotides comprise cytidine 5′-monophosphate, disodium uridine 5′-monophosphate, adenosine 5′-monophosphate, disodium guanosine-5 monophosphate, or combinations thereof.

An embodiment relates to the nutritional formula above, where the lactose comprises at least 90% of total carbohydrates.

An embodiment relates to the nutritional formula above, where the nutritional formula comprises approximately 4.39 grams to 5.36 grams of the oil blend per 100 kilocalories.

An embodiment relates to the nutritional formula above, where the enriched whey protein concentrate comprises at least 60% of the total protein.

An embodiment relates to the nutritional formula above, where the nutritional formula comprises approximately 7.1 micrograms-50.2 micrograms of choline per 100 kilocalories.

An embodiment relates to the nutritional formula above, where the arachidonic acid (ACA) comprises up to 1% of the total fat.

An embodiment relates to the nutritional formula above, where the docosahexaenoic acid (DHA) comprises up to 0.5% of the total fat.

An embodiment relates to the nutritional formula above, where the nutritional formula comprises approximately 21 milligrams to 59 milligrams of sodium citrate per 100 kilocalories.

An embodiment relates to the nutritional formula above, where the lactoferrin nutritional formula comprises up to 1 gram per kilogram of lactoferrin.

An embodiment relates to the nutritional formula above, where the nutritional formula comprises approximately 4.2 grams to 39.7 grams of inositol per 100 kilocalories.

An embodiment relates to the nutritional formula above, where the nutritional formula comprises up to 13 milligrams of taurine per 100 kilocalories.

An embodiment relates to the nutritional formula above, where the nutritional formula comprises approximately 0.42 milligrams to 1.51 milligrams of iron per 100 kilocalories.

An embodiment relates to the nutritional formula above, where the nutritional formula comprises at least 1.3 milligrams of L-carnitine per 100 kilocalories.

An embodiment relates to the nutritional formula above, where the nutritional formula comprises approximately 0.5 milligrams to 1.51 milligrams of zinc per 100 kilocalories.

An embodiment relates to the nutritional formula above, where the nutritional formula comprises approximately 0.12 grams to 0.58 grams per kilogram of nucleotides per 100 kilocalories.

An embodiment relates to the nutritional formula above, where the nutritional formula comprises approximately 402 micrograms to 2000 micrograms of pantothenic acid per 100 kilocalories.

An embodiment relates to the nutritional formula above, where the nutritional formula comprises approximately 35.6 micrograms to 121.3 micrograms of copper per 100 kilocalories.

An embodiment relates to the nutritional formula above, where the nutritional formula comprises approximately 1.5 micrograms to 10 micrograms of D-biotin per 100 kilocalories.

An embodiment relates to the nutritional formula above, where the nutritional formula comprises approximately 10.5 micrograms to 50.2 micrograms of folic acid per 100 kilocalories.

An embodiment relates to the nutritional formula above, where the nutritional formula comprises approximately 300 micrograms to 2000 micrograms per kilogram of lutein per 100 kilocalories.

An embodiment relates to the nutritional formula above, where the nutritional formula comprises approximately 10.5 micrograms to 58.6 micrograms of iodine per 100 kilocalories.

An embodiment relates to the nutritional formula above, where the nutritional formula comprises approximately 2.01 micrograms to 7.95 micrograms of selenium per 100 kilocalories.

An embodiment relates a method of providing nutrition to a subject, the method including administering any of the formulas discussed above the subject.

An embodiment relates a method of providing nutrition to a subject, the method including: reconstituting any of the formulas discussed above with water to form a ready-to-feed liquid.

An embodiment relates to the method above, further including feeding the subject with approximately 8.8 grams per 2 ounces of water of the reconstituted formula per feeding.

An embodiment relates to the method above, further including feeding the subject with approximately 17.6 grams per 4 ounces of water of the reconstituted formula per feeding.

An embodiment relates to the method above, further including feeding the subject with approximately 35.2 grams per 8 ounces of water of the reconstituted formula per feeding.

An embodiment relates to a kit having: one or more packages of any of the nutritional formulas discussed above; and instructions for feeding the nutritional formula to a subject.

An embodiment relates to the kit above, further including a dehydrated form of the nutritional formulas above.

The formulas disclosed herein provide benefits over and solve defects with existing formulas. For example, some embodiments comprise sodium citrate as a buffer to optimize the pH level of the formula. Some embodiments comprise L-Choline bitartrate (41% by weight) as it has a lower hygroscopicity (dissolvability) than other commonly used forms of choline (e.g. choline dihydrogen citrate). In some embodiments, ingredients such as osteopontin, polydextrose, and magnesium oxide are excluded as the use of such ingredients in infant formulas is prohibited. In some embodiments, protein levels are achieved with non-fat milk, demineralized whey, whey protein concentrate, enriched whey protein concentrate and Lactoferrin; in such embodiments beta-casein enriched milk protein is not used.

In some embodiments, the formulas disclosed herein only include the ingredients disclosed above. In some embodiments, the formulas disclosed herein only include the ingredients disclosed above in the amounts or amount ranges disclosed above and throughout this disclosure. In some embodiments, the formulas disclosed herein exclude ingredients not explicitly disclosed above and throughout this disclosure. In some embodiments, the formulas above exclude one or more of the following ingredients osteopontin, beta-casein enriched milk protein, mildly hydrolyzed milk protein, polydextrose, and di-magnesium phosphate.

The following describes some embodiments of the current invention more specifically. The general concepts of this invention are not limited to these particular embodiments.

### EXAMPLES

Traditional infant formulas have been associated with several undesirable side effects in the infant including unhealthy weight gain and intestinal issues. These side effects have been linked to the fact that these formulas generally have higher levels of total protein than natural breast milk. In addition, the protein and fat composition of traditional formulas differ greatly from the protein and fat composition of natural breast milk. Examples of the invention described below relate to infant formulas that more closely resemble the protein and fat levels and composition of natural breast milk. Such examples have been observed to be easier to digest, to support the development of beneficial flora in the intestinal tract, to support the immune system, and to support healthy weight gain and bone growth.

### Example 1

An example formula includes the ingredients in Table 1 below in the indicated amounts.

TABLE 1
Example Infant Formula

| | Amount (in grams |
|---|---|
| Ingredient | per 100 grams) |
| NON-FAT DRY MILK POWDER | 24.00000000 |
| LACTOSE | 23.95000000 |
| OIL BLEND | 27.80000000 |
| DEMINERALIZED WHEY | 13.50000000 |
| WHEY PROTEIN CONCENTRATE (WPC) | 5.099 |
| ENRICHED WHEY PROTEIN | 1.71000000 |
| CONCENTRATE | |
| GALACTOOLIGOSACCHARIDES (GOS) | 1.71000000 |
| FRUCTOOLIGOSACCHARIDES (FOS) | 0.19055000 |
| CHOLINE (CHOLINE DIHYDROGEN | 0.37277 |
| CITRATE) | |
| CALCIUM CARBONATE | 0.3702211 |
| POTASSIUM CHLORIDE | 0.32936910 |
| DOCOSAHEXAENOIC ACID (DHA) | 0.30294 |
| ARACHIDONIC ACID (ARA) | 0.244625 |
| MAGNESIUM OXIDE/(MAGNESIUM | 0.07827000 |
| CHLORIDE) | |
| SODIUM (SODIUM CHLORIDE/SODIUM | 0.07000000 |
| CITRATE) | |
| VITAMIN C (L-ASORBIC ACID) | 0.06403 |
| ASCORBYL PALMITATE | |
| LACTOFERRIN | 0.047 |
| INOSITOL (MYO-INOSITOL/D-CHIRO- | 0.03234000 |
| INOSITOL) | |
| TAURINE | 0.03095 |
| IRON (AS FERROUS SULFATE) | 0.02148 |
| L-CARNITINE (AS L-TARTRATE) | 0.01504000 |
| ZINC (AS ZINC SULFATE) | 0.0132 |
| CYTIDINE-5 MONOPHOSPHATE | 0.01216000 |
| DISODIUM URIDINE-5 | 0.00948 |
| MONOPHOSPHATE | |
| ADENOSINE-5 MONOPHOSPHATE | 0.0064 |
| VITAMIN B3 (AS NIACINAMIDE) | 0.00583 |
| NIACIN | |
| SOY LECITHIN | 0.00300000 |
| PANTOTHENIC ACID (D-CALCIUM | 0.0028428 |
| PANTOTHENATE) | |
| DISODIUM GUANOSINE-5 | 0.00272000 |
| MONOPHOSPHATE | |
| VITAMIN E (as DI-ALPHA TOCOPHEROL | 0.0019 |
| ACETATE) (DL-A-VITAMIN E ACETATE) | |
| VITAMIN K1 (as PHYTONADIONE) | 0.0009 |
| VITAMIN B2 (RIBOFLAVIN) | 0.0007623 |
| COPPER (as CUPRIC SULFATE) | 0.00075 |
| VITAMIN A (as RETINYL PALMITATE) | 0.00047534 |
| BIOTIN (D BIOTIN) | 0.0003 |
| VITAMIN B12 (AS CYANOCOBALAMIN) | 0.00015845 |
| POTASSIUM CITRATE | 0.0001126 |
| VITAMIN B1 (as THIAMINE HCL) | 0.00010200 |
| THIAMINE | |
| HYDROCHLORIDE/THIAMINE NITRATE | |
| FOLIC ACID | 0.00008893 |
| VITAMIN B6 (as PYRIDOXINE HCL) | 0.00007400 |
| LUTEIN | 0.00006400 |
| MANGANESE (as MANGANESE | 0.00004687 |
| SULFATE) | |
| IODINE (as POTASSIUM IODIDE) | 0.00001962 |
| BETACAROTENE (β CAROTENE) | 0.00001900 |
| SELENIUM (as SODIUM SELENITE) | 0.00000739 |
| VITAMIN D3 (as CHOLECALCIFEROL) | 0.00000150 |

In the embodiment above, the oil blend comprises each of 10 grams of sunflower oil, 9.25 grams of soy oil, 7.85 grams of coconut oil, and 0.7 grams of SN2 palmitate per 100 grams.

### Example 2

An example formula includes the ingredients in Table 2 below in the indicated amount ranges.

TABLE 2
Example Infant Formula.

| Ingredient | Amount Range (unit) |
|---|---|
| NON-FAT DRY MILK POWDER | N/A |
| LACTOSE | At least 90% of total carbohydrates |
| OIL BLEND | 4.39-5.6 (grams per 100 kcal) |
| | The total amount of lauric acid and myristic |
| | acid (tetradecanoic acid) is less than 20% of |
| | the total fatty acid in the final product. The |
| | maximum content of trans-fatty acids is less |
| | than 3% of total fatty acid. Erucic acid is less |
| | than 1% of total fatty acid. |
| PROTEINS (DEMINERALIZED WHEY | 1.88-2.93 (grams per 100 kcal) Whey protein |
| AND DEMINERALIZED WHEY | must account for at least 60% of the total |
| POWDERS) | protein. Protein/(g/100 g) ≥10.0; Ash/ |
| | (g/100 g) ≤3.0; Moisture(g/100 g) ≤5.0 |
| WHEY PROTEIN CONCENTRATE (WPC) | Protein/(g/100 g) ≥25 |
| | Ash/(g/100 g) ≤9 |
| | Moisture(g/100 g) ≤6 |
| ENRICHED WHEY PROTEIN | Protein/(g/100 g) ≥25 |
| CONCENTRATE | Ash/(g/100 g) ≤9 |
| | Moisture(g/100 g) ≤6 |
| GALACTOOLIGOSACCHARIDES (GOS) | Up to 65.4 grams per kilogram |
| FRUCTOOLIGOSACCHARIDES (FOS) | Up to 65.4 grams per kilogram |
| CHOLINE (CHOLINE DIHYDROGEN | 7.1-50.2 (micrograms per 100 kcal) |
| CITRATE) | |
| CALCIUM | 50-146 (milligrams per 100 kcal) |
| POTASSIUM | 59-180 (milligrams per 100 kcal) |
| DOCOSAHEXAENOIC ACID (DHA) | Up to 0.5% of total fat |
| ARACHIDONIC ACID (ARA) | Up to 1% of total fat |
| MAGNESIUM | 5.0-15.1 (milligrams per 100 kcal) |
| SODIUM | 21-59 (milligrams per 100 kcal) |
| VITAMIN C | 10.5-71.1 (milligrams per 100 kcal) |
| LACTOFERRIN | Up to 1 (gram per kilogram) |
| INOSITOL (MYO-INOSITOL/D-CHIRO- | 4.2-39.7 (micrograms per 100 kcal) |
| INOSITOL) | |
| TAURINE | Up to 13 (milligrams per 100 kcal) |
| IRON (AS FERROUS SULFATE) | 0.42-1.51 (milligrams per 100 kcal) |
| L-CARNITINE (AS L-TARTRATE) | At least 1.3 (milligrams per 100 kcal) |
| ZINC | 0.5-1.51 (milligrams per 100 kcal) |
| NUCLEOTIDES | 0.12-0.58 (grams per kilogram) |
| NIACIN | 293-1506 (micrograms per 100 kcal) |
| SOY LECITHIN | N/A |
| PANTOTHENIC ACID | 402-2000 (micrograms per 100 kcal) |
| PHOSPHOROUS | 25-100 (milligrams per 100 kcal) |
| VITAMIN E | 0.75-7.49 (IU) |
| VITAMIN K | 4.2-27.2 (micrograms per 100 kcal) |
| VITAMIN B2 | 80-498 (micrograms per 100 kcal) |
| COPPER | 35.6-121.3 (micrograms per 100 kcal) |
| VITAMIN A | 197-600 (IU) |
| BIOTIN (D BIOTIN) | 1.5-10.0 (micrograms per 100 kcal) |
| VITAMIN B12 | 0.105-1.506 (micrograms per 100 kcal) |
| POTASSIUM CITRATE | N/A |
| VITAMIN B1 | 59-301 (micrograms per 100 kcal) |
| FOLIC ACID | 10.5-50.2 (micrograms per 100 kcal) |
| VITAMIN B6 | 35.6-188.3 (micrograms per 100 kcal) |
| LUTEIN | 300-2000 (micrograms per kilogram) |
| MANGANESE | 5.0-100.4 (micrograms per 100 kcal) |
| IODINE | 10.5-58.6 (micrograms per 100 kcal) |
| BETACAROTENE (β CAROTENE) | 197-600 (IU) |
| SELENIUM | 2.01-7.95 (micrograms per 100 kcal) |
| VITAMIN D | 42-100 (IU) |

### Example 3

An example formula includes the ingredients in Table 3 below, and/or any of the alternative ingredients listed.

TABLE 3
Example Infant Formula with additional
and/or alternative ingredients.

| Ingredient | Alternative Ingredient(s) |
|---|---|
| NON-FAT DRY MILK POWDER | SKIMMED MILK POWDER |
| | NFDM |
| LACTOSE | |
| OIL BLEND | SUNFLOWER |
| | SAFFLOWER |
| | SOY/SOYBEAN |
| | COCONUT |
| | OPO SN2 |
| | 1,3-DIOLEOYL-2- |
| | PALMITOYL-GLYCEROL |
| | (HIGH OLEIC) |
| DEMINERALIZED WHEY | REDUCED MINERAL WHEY |
| WHEY PROTEIN | WHEY PROTEIN ISOLATE |
| CONCENTRATE (WPC) | WHEY PROTEIN |
| | HYDROLYSATE |
| ENRICHED WHEY PROTEIN | A-LACTALBUMIN ENRICHED |
| CONCENTRATE | ALPHA-LACTALBUMIN |
| | ENRICHED |
| GALACTOOLIGOSACCHARIDES | OLIGOGALACTOSYLLACTOSE |
| (GOS) | OLIGOGALACTOSE |
| | OLIGOLACTOSE |
| FRUCTOOLIGOSACCHARIDES | OLIGOFRUCTOSE |
| (FOS) | OLIGOFRUCTAN |
| CHOLINE | CHOLINE DIHYDROGEN |
| | CITRATE |
| | L-CHOLINE |
| | L-CHOLINE BITARTRATE |
| | CHOLINE HYDROXIDE |
| CALCIUM CARBONATE | CALCIUM CARBONATE |
| | (PRECIPITATED) |
| POTASSIUM CHLORIDE | KCl |
| | POTASSIUM SALT |
| DOCOSAHEXAENOIC ACID | CERVONIC ACID |
| (DHA) | DOCONEXENT |
| ARACHIDONIC ACID (ARA) | ALL-CIS 5,8,11,14- |
| | EICOSATETRAENOIC ACID |
| MAGNESIUM | MAGNESIUM OXIDE |
| | MAGNESIA |
| | PERICLASE |
| | MAGNESIUM CHLORIDE |
| | MAGNESIUM DICHLORIDE |
| SODIUM | SODIUM CHLORIDE |
| | SODIUM CITRATE |
| | TRISODIUM CITRATE |
| VITAMIN C | ASORBIC ACID |
| | L-ASORBIC ACID |
| | ASCORBYL PALMITATE |
| LACTOFERRIN | LACTOTRANSFERRIN (LTF) |
| INOSITOL | MYO-INOSITOL |
| | D-CHIRO-INOSITOL |
| TAURINE | 2-AMINOETHANESULFONIC |
| | ACID TAURIC ACID |
| IRON | FERROUS SULFATE |
| | IRON SULFATE |
| L-CARNITINE | L-TARTRATE |
| ZINC | ZINC SULFATE |
| CYTIDINE-5 MONOPHOSPHATE | CYTIDINE MONOPHOSPHATE |
| | 5′-CYTIDYLIC ACID |
| | CYTIDYLATE (CMP) |
| DISODIUM URIDINE-5 | URIDINE-5 MONOPHOSPHATE |
| MONOPHOSPHATE | DISODIUM SALT |
| ADENOSINE-5 | 5′-ADENYLIC ACID |
| MONOPHOSPHATE | |
| VITAMIN B3 - NIACINAMIDE | NIACIN |
| | NICOTINIC ACID |
| SOY LECITHIN | |
| VITAMIN B5 - PANTOTHENIC | D-CALCIUM PANTOTHENATE |
| ACID | CALCIUM D PANTOTHENATE |
| DISODIUM GUANOSINE-5 | 5′-GUANIDYLIC ACID |
| MONOPHOSPHATE | GUANYLIC ACID |
| VITAMIN E - DL-ALPHA | DL-A- TOCOPHEROL |
| TOCOPHEROL ACETATE | ACETATE |
| | DL-A-VITAMIN E ACETATE |
| | D ALPA TOCOPHEROL |
| | ACETATE |
| VITAMIN K1 - PHYTONADIONE | PHYLLOQUINONE |
| VITAMIN B2 - RIBOFLAVIN | |
| COPPER | CUPRIC SULFATE |
| | COPPER SULPHATE |
| VITAMIN A - RETINYL | VITAMIN A PALMITATE |
| PALMITATE | RETINOL PALMITATE |
| BIOTIN | D BIOTIN |
| VITAMIN B12 - AS | |
| CYANOCOBALAMIN | |
| POTASSIUM CITRATE | TRIPOTASSIUM CITRATE |
| VITAMIN B1 - THIAMINE | THIAMINE HCL |
| HYDROCHLORIDE | THIAMINE NITRATE |
| FOLIC ACID | FOLATE |
| | FOLACIN |
| VITAMIN B6 - PYRIDOXINE HCL | PYRIDOXINE |
| | HYDROCHLORIDE |
| LUTEIN | |
| MANGANESE | MANGANESE (II) SULFATE |
| IODINE | POTASSIUM IODIDE |
| BETACAROTENE | β CAROTENE |
| SELENIUM | SODIUM SELENITE |
| VITAMIN D3 - | COLECALCIFEROL |
| CHOLECALCIFEROL | |

### Example 4

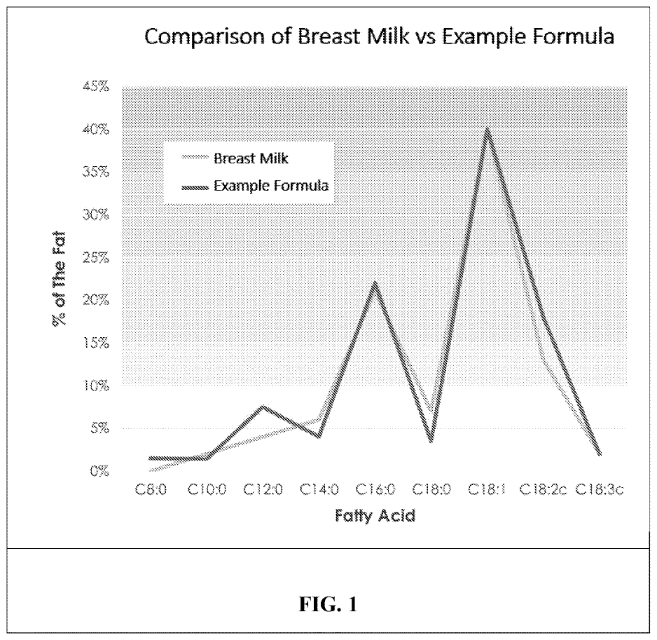

An example formula includes at least a 1,3-olein-2-palmitin (OPP) SN2 fat blend, alpha-lactalbumin, prebiotics, lactoferrin, lutein as well as other ingredients. As seen in FIG. 1, the fatty acid content of the formula closely resembles that of breast milk. More specifically, each of octanoic acid (C8:0), decanoic acid (C10:0), tetradecanoic acid (C14:0), octadecanoic acid (C18:0), and cis alpha linoleic acid (C18:3c) make up less than 5% of the total % fat; dodecanoic acid (C12:0) makes up between 5% and 10% of the % total fat; hexadecanoic acid (C16:0) makes up between 20% and 25% of the % total fat; oleic acid (C18:1) makes up about 40% of the % total fat; and linoleic acid (C18:2c) makes up about 15% to 25% of the % total fat. The formula was observed to significantly reduce the level of calcium in the stool, to reduce gastroesophageal reflux, constipation, and vomiting over a leading brand.

### Example 5

An example formula includes alpha-lactalbumin enriched whey protein, where alpha-lactalbumin makes up about 25% of the total protein content in the formula. Similarly, about 25% of the total protein content in human breast milk is made up from alpha-lactalbumin. In some embodiments of such an example, the total protein content of the formula is less than that of traditional infant formula. For example, whereas traditional infant formulas contain about 1.5 grams of alpha-lactalbumin per liter in about a total 14-17 grams of total protein per liter, some embodiments of the instant formula contain about 2.5-3.0 grams of alpha-lactalbumin per liter in about a total of 12-13 grams of total protein per liter—by comparison, human breast milk contains about 2.5 grams of alpha-lactalbumin per liter in about a total 9-11 grams of total protein per liter. Such a formula was seen to promote heathier weight gain and to reduce instances of diarrhea.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. Moreover, features described in connection with one embodiment of the invention may be used in conjunction with other embodiments, even if not explicitly stated above. It is therefore to be understood that, within the scope of the claims and their equivalents, the invention may be practiced otherwise than as specifically described.

1. A nutritional formula comprising: non-fat milk powder, lactose, an oil blend, enriched whey protein concentrate, oligosaccharides, choline, arachidonic acid (ACA), docosahexaenoic acid (DHA), magnesium oxide, lactoferrin, inositol, taurine, iron, L-carnitine, zinc, nucleotides, soy lecithin, pantothenic acid, copper, D-biotin, folic acid, lutein, manganese sulfate, iodine, Beta-carotene, sodium citrate, and selenium.

2. The nutritional formula of claim 1, further comprising one or more of demineralized whey powder and whey protein concentrate.

3. The nutritional formula of claim 1, wherein the oligosaccharides comprise galacto-oligosaccharide (GOS), fructo-oligosaccharide (FOS), or combinations thereof.

4. The nutritional formula of claim 1, further comprising one or more of calcium carbonate, di-calcium phosphate, potassium citrate, potassium chloride, potassium iodide, magnesium chloride, sodium citrate, sodium chloride, zinc sulfate, copper sulfate, and sodium selenite.

5. The nutritional formula of claim 1, wherein the vitamins comprise L-ascorbic acid, ascorbyl palmitate, niacinamide, D-calcium pantothenate, vitamin A, vitamin A palmitate, vitamin B1, vitamin B2, vitamin B3, vitamin B6, vitamin B12, vitamin C, vitamin D3, riboflavin, thiamin hydrochloride, vitamin B6 hydrochloride, folic acid, vitamin K1, vitamin E, or combinations thereof.

6. The nutritional formula of claim 1, wherein the nucleotides comprise cytidine 5′-monophosphate, disodium uridine 5′-monophosphate, adenosine 5′-monophosphate, disodium guanosine-5 monophosphate, or combinations thereof.

7. The nutritional formula of claim 1, wherein the lactose comprises at least 90% of total carbohydrates.

8. The nutritional formula of claim 1, wherein the nutritional formula comprises approximately 4.39 grams to 5.36 grams of the oil blend per 100 kilocalories.

9. The nutritional formula of claim 1, wherein the enriched whey protein concentrate comprises at least 60% of the total protein.

10. The nutritional formula of claim 1, wherein the nutritional formula comprises approximately 7.1 micrograms-50.2 micrograms of choline per 100 kilocalories.

11. The nutritional formula of claim 1, wherein the arachidonic acid (ACA) comprises up to 1% of the total fat.

12. The nutritional formula of claim 1, wherein the docosahexaenoic acid (DHA) comprises up to 0.5% of the total fat.

13. The nutritional formula of claim 1, wherein the nutritional formula comprises approximately 21 milligrams to 59 milligrams of sodium citrate per 100 kilocalories.

14. The nutritional formula of claim 1, wherein the lactoferrin nutritional formula comprises up to 1 gram per kilogram of lactoferrin.

15. The nutritional formula of claim 1, wherein the nutritional formula comprises approximately 4.2 grams to 39.7 grams of inositol per 100 kilocalories.

16. The nutritional formula of claim 1, wherein the nutritional formula comprises up to 13 milligrams of taurine per 100 kilocalories.

17. The nutritional formula of claim 1, wherein the nutritional formula comprises approximately 0.42 milligrams to 1.51 milligrams of iron per 100 kilocalories.

18. The nutritional formula of claim 1, wherein the nutritional formula comprises at least 1.3 milligrams of L-carnitine per 100 kilocalories.

19. The nutritional formula of claim 1, wherein the nutritional formula comprises approximately 0.5 milligrams to 1.51 milligrams of zinc per 100 kilocalories.

20. The nutritional formula of claim 1, wherein the nutritional formula comprises approximately 0.12 grams to 0.58 grams per kilogram of nucleotides per 100 kilocalories.

21. The nutritional formula of claim 1, wherein the nutritional formula comprises approximately 402 micrograms to 2000 micrograms of pantothenic acid per 100 kilocalories.

22. The nutritional formula of claim 1, wherein the nutritional formula comprises approximately 35.6 micrograms to 121.3 micrograms of copper per 100 kilocalories.

23. The nutritional formula of claim 1, wherein the nutritional formula comprises approximately 1.5 micrograms to 10 micrograms of D-biotin per 100 kilocalories.

24. The nutritional formula of claim 1, wherein the nutritional formula comprises approximately 10.5 micrograms to 50.2 micrograms of folic acid per 100 kilocalories.

25. The nutritional formula of claim 1, wherein the nutritional formula comprises approximately 300 micrograms to 2000 micrograms per kilogram of lutein per 100 kilocalories.

26. The nutritional formula of claim 1, wherein the nutritional formula comprises approximately 10.5 micrograms to 58.6 micrograms of iodine per 100 kilocalories.

27. The nutritional formula of claim 1, wherein the nutritional formula comprises approximately 2.01 micrograms to 7.95 micrograms of selenium per 100 kilocalories.

28-31. (canceled)
